(19) United States
(12) Patent Application Publication
(10) Pub. No.: US 2007/0025630 A1
(43) Pub. Date: Feb. 1, 2007

(54) Method and apparatus of image compression

(76) Inventors: Chih-Ta Star Sung, Glonn (DE); Yin-Chun Blue Lan, Wurih Township (TW)

Correspondence Address: Chih-Ta Star Sung, RM. 308, BLD. 52, NO. 195, CHUNG HSING RD., SEC. 4, CHU TUNG TOWNSHIP, HSINCHU COUNTY, 310, TW

(21) Appl. No.: 11/190,042

(22) Filed: Jul. 27, 2005

(51) Int. Cl. G06K 9/36; G06K 9/46

(52) U.S. Cl. 382/246; 382/238

(57) ABSTRACT

The differential values of adjacent pixels of a group of pixels are calculated and are re-ordered by referring to the magnitude of pixels of a neighboring line. Another time of calculation of differential values of the re-ordered differential values of adjacent pixels is done and the results go through a procedure of a variable length coding. When complex pattern happened, a market code is asserted to break the calculating the differences of adjacent pixels followed by a new raw pixel data as a reference for a new group of pixel. The variable length coding only keeps the “Quotient” and “Remainder” with the “Divider” implicitly done by prediction.

### BACKGROUND OF THE INVENTION

1. Field of Invention

The present invention relates to compression techniques for digital images data reduction, and particularly relates to lossless and near lossless compression of the digitized image.

2. Description of Related Art

Due to the sharp quality and convenience in storage, the digital image has become popular in mass applications like digital camera, digital camcorder, digital photo albums, scanner/printer/fax, image archiving and storage . . . . Most popular still image compression standards including JPEG are lossy algorithms which cause data loss during the procedure of image compression. The data loss caused by lossy compression algorithm degrades the image quality which might not be acceptable in some applications.

There are very few lossless image compression algorithms of image data reduction. One of most known approach is taking differential value between adjacent pixels and applying the so called “entropy coding” or “Variable Length Coding” method which applying shortest code to represent the most frequent happened pattern.

Lossy compression algorithms can achieve higher compression rate, said 10 to 20 times, at the cost of sacrificing the image quality. Sharp image quality can be achieved by the lossless compression algorithm but the compression rate is most likely much lower than that of the lossy algorithms.

The method and apparatus of this invention of image compression is to achieve a reasonable higher compression rate compared to prior arts lossless compression algorithms without sacrificing the image quality.

### SUMMARY OF THE INVENTION

The present invention of image compression reduces image data without sacrificing the image quality or still keeping good image quality by reliable method.
The present invention of image compression calculates the differential value of adjacent pixels.
According to an embodiment of this invention of image compression, the differential values of adjacent pixels are re-ordered according to the magnitude of a neighboring line.
According to an embodiment of this invention of image compression, the differential values are calculated between the adjacent values of the re-ordered differential values and go through an entropy coding to further reduce the code length.
According to another embodiment of this invention of image compression, a certain amount of group of the re-ordered differential values don not go through compression procedure.
According to an embodiment of this invention of image compression, a code named “End-Of Line”, EOL with shortest code, is applied to represent “No non-zero” of the rest of line.
According to an embodiment of the VLC coding algorithm of the differential values of the present invention of image compression, only the “Quotient” and “Remainder” are coded, and the “Divider” is implicitly calculated by prediction.
According to another embodiment of this invention of image compression, a lossy algorithm is optionally applied to achieve higher compression rate with a little sacrifice of image quality.
According to another embodiment of this invention of image compression, a half line as a compression unit is applied to save the computing power.
According to another embodiment of this invention of image compression, a segment of a certain amount of pixels is used as a compression unit in compression which significantly saves the computing power.
According to another embodiment of this invention of image compression, a marker code is asserted to break the chain of calculating differences of adjacent pixels and followed by a raw pixel data as the reference of the next group of pixels.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1 depicts a prior art, he JPEG still image compression procedure.

FIG. 2 depicts another. prior art of image compression: differential value of adjacent pixels with variable length coding.

FIG. 3 illustrates the procedure of the method of this invention of image compression.

FIG. 4 lists a table of raw image data.

FIG. 5 shows an example of differential values of the adjacent pixels of an image.

FIG. 6 shows a table the reordered differential values of the adjacent pixles.

FIG. 7 shows a procedure of variable length coding and final data packing.

FIG. 8 illustrates the procedure of compression with lossy and lossless algorithms.

FIG. 9 illustrates the half. line based method of the image compression which saves computing times.

FIG. 10 illustrates a segment based method of the image compression which significantly saves computing times.

### DESCRIPTION OF THE PREFERRED EMBODIMENTS

Due to sharp quality and good immunity to the noise, and convenient in storage, the digital image has prevailingly become popular in mass applications like digital camera, digital camcorder, digital photo albums, scanner/printer/fax, image archiving and storage . . . etc.

For saving the requirement of density of storage device and time of transmission, image compression technology has been applied to reduce the data rate of the digital image. In the past decades, many image compression algorithms have been applied to image applications. Some are lossy and very few are lossless. Lossy means the recovered or decompressed image from a compressed image will have data loss compared to the original image.
ITU and ISO have developed and defined some image and video compression algorithms including JPEG, an still image compression standard and MPEG, the video compression standard. The JPEG image has widely applications with the cost of data loss compared to the original image.

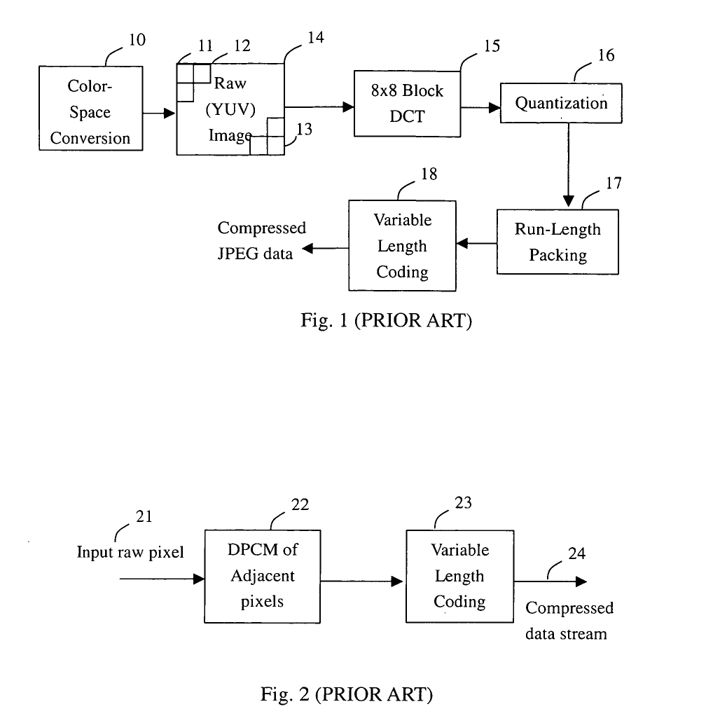

JPEG image compression as shown in FIG. 1 includes some procedures in compression. The color space conversion 10 is to separate the luminance (brightness) from chrominance (color) and to take advantage of human being's vision less sensitive to chrominance than to luminance and the can reduce more chrominance element without being noticed . An image 14 is partitioned into many units of so named “Block” of 8×8 pixels to run the JPEG compression.

A color space conversion 10 mechanism transfers each 8×8 block pixels of the R(Red), G(Green), B(Blue) components into Y(Luminance), U(Chrominance), V(Chrominance) and further shifts them to Y, Cb and Cr. JPEG compresses 8×8 block of Y, Cb, Cr 11, 12, 13 by the following procedures: Step 1: Discrete Cosine Transform (DCT), Step 2: Quantization Step 3: Zig-Zag scanning, Step 4: Run-Length pair packing and Step 5: Variable length coding (VLC).

DCT 15 converts the time domain pixel values into frequency domain. After transform, the DCT “Coefficients” with a total of 64 subbabd of frequency represent the block image data, no long represent single pixel. The 8×8 DCT coefficients form the 2-dimention array with lower frequency accumulated in the left top corner, the farer away from the left top, the higher frequency will be. Further on, the more closer to the left top, the more DC frequency which dominates the more information. The more right bottom coefficient represents the higher frequency which less important in dominance of the information. Like filtering, quantization 16 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss. The larger the quantizationj step, the higher the compression and the more distortion the image will be.

After quantization, most DCT coefficient in the right bottom direction will be rounded to “Os” and only a few in the left top corner are still left non-zero which allows another step of said “Zig-Zag” scanning and Run-Length packing 17 which starts left top DC coefficient and following the zig-zag direction of scanning higher frequency coefficients. The Run-Length pair means the number of “Runs of continuous 0s”, and value of the following non-zero coefficient.

The Run-Length pair is sent to the so called “Variable Length Coding” 18 (VLC) which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lossless compression. JPEG is a lossy compression algorithm, the JPEG picture with less than 10× compression rate has sharp image quality, 20× compression will have more or less noticeable quality degradation.

The JPEG compression procedures are reversible, which means the following the backward procedures, one can decompresses and recovers the JPEG image back to raw and uncompressed YUV (or further on RGB) pixels.

Very few lossless image compression algorithms have been developed due to the following two factors:
The standard JPEG Image with 10× compression rate has still acceptable good image quality.
It is tough to achieve high compression rate of the lossless compression.

A well know prior art of the lossless image compression method is shown in FIG. 2 which calculates the differential value 22 of the input adjacent pixels 21 and runs the variable length coding 23, the VLC coding. A VLC coding uses the shortest code to represent the most frequent happen pattern, and longer code to represent the less frequent happen pattern. The disadvantage of the prior art in FIG. 2 is that it can not reach higher compression rate.

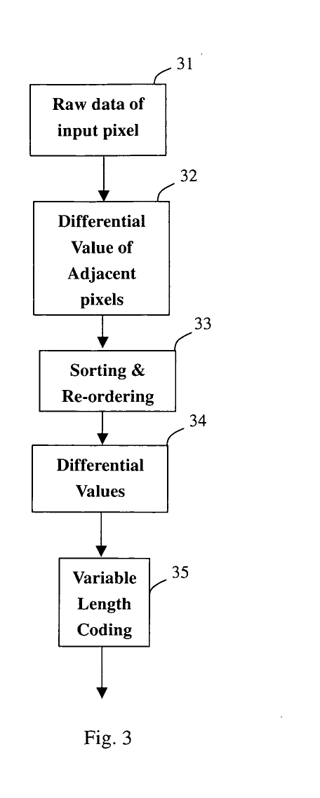

This invention of the image compression overcomes disadvantages of both JPEG and another prior art of VLC coding the differential values of adjacent pixel in quality and compression rate issues. FIG. 3 depicts the procedure of this method of image compression. The raw image data 31 is calculated and results in the differential values of adjacent pixels 32. The calculated differential values of adjacent pixels are then reordered 33 according to the magnitude of differential values of adjacent pixels of the upper line. When the differential values are equal, the left-to-right order is followed. After re-ordering, the higher the differential values, the more left column the numbers will be put together. And since the digital image is more likely large resolution, many numbers of differential values of adjacent pixels will have same or close numbers. The next step is to calculate the differential values 34 of the re-ordered differential values of the adjacent pixels the adjacent pixels. The results are coded by a variable length coding 35.

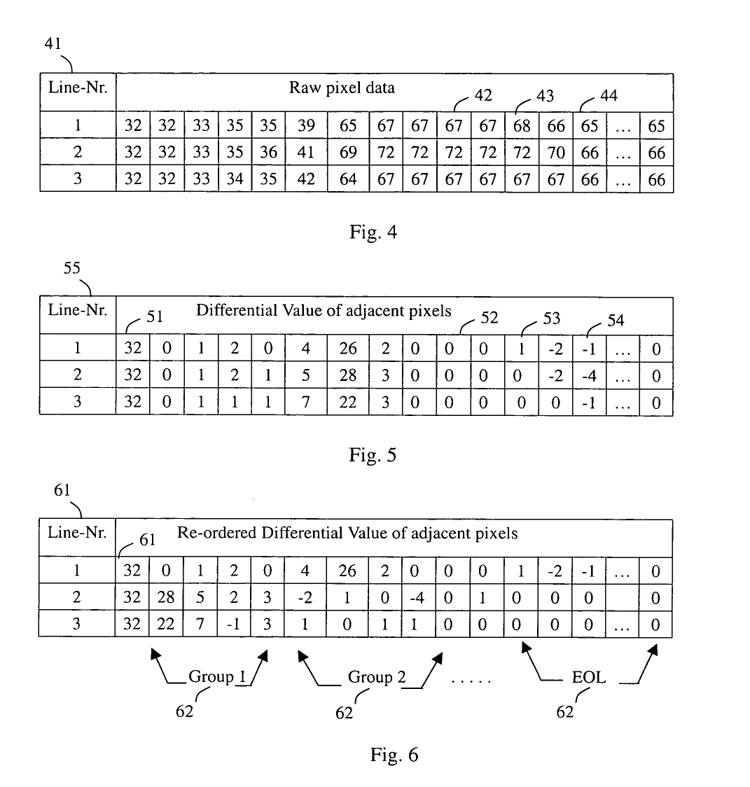

FIG. 4 to FIG. 6 show an example to describe the procedure of this invention of image compression. As shown in FIG. 4, the 1^{st} column represents the number of line, or said row of an image, the raw data values 42, 43, 44 . . . of an image are listed till end of line. FIG. 5 lists the numbers of differential values 52, 53, 54 . . . of adjacent pixels with the 1^{st} pixel of a line as reference 51 of raw data as a starting pixel. From this FIG., it is obvious that many “0s” or small values like “1s” and “−1s” are showing up. The line number 55 is the same as the raw pixels shown in FIG. 5.

After calculating the differential values of adjacent pixels as described in FIG. 4, the results of differential values are re-ordered according to the magnitude of closest neighboring line, for example, the upper line. When image with large resolution, the differential values of adjacent pixels will have high probability of having the same value, when this occurrence happens, the rule of left-to-right order is applied to the re-ordering. This step of re-ordering according to the magnitude helps putting together all differential values with the same or similar magnitude as a “group” 62, 63, 64. The 1^{st} number of each line is still the reference 61 for encoding and decoding. In the end of each line, there will be a group of all “0s” which can be coded by a shortest code, said “00” to represent “end of line” or “no-non-zero”.

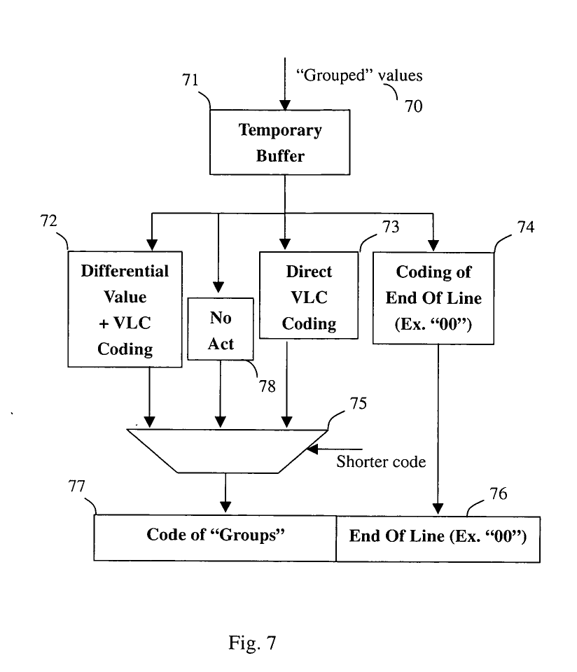

FIG. 7 illustrates the compression procedure of each “Group” of the re-ordered differential values. Each “group” values 70 will have high degree of equal values or at least similar values and further calculating the differential values between values within a “group” 72 and applying a VLC coding algorithm will further reduce the data rate of each group. Since some groups might have few values or/and values with large difference and no benefit in calculating the differential value. In case of this kind of condition, directly applying a “VLC” coding 73 might gain shorter code. Both “Differential coding +VLC” 72 and “Direct VLC” 73 coding and “No Act” 78 which does not go through any further compression procedure will be functioning for each “group” and an output multiplexer 77 selected the one with shorter code as the output to be packed with other selected groups code and the last code of “end-of-line” 74, 76 (or said “non-no-zero”) to form the final compressed image bit stream.

The differential values between the re-ordered differential values of adjacent pixels are calculated and coded by the following equation:
D_{—}n=Q×M+R (Q: Quotient, M: Divider, R: Remainder) Eq. (1)
the “Quotient” and “Remainder” are coded with the “Divider” implicitly done by prediction. For example: 12=2×5+2, in the VLC coding of this invention, the Y=1 and R=2 are the only two parameters needed to be coded with the M=5 implicitly predicted by an average of weighted factors times Ms of previous pixels. 1^{st} step of the VLC coding is to predict the value of M, the divider. Eq. (2) illustrates the means of predicting the value of M.
M_{—}n=(Mn−1+D_{—}n)/2 Eq. (2)

As one can see that the Dn of the closest previous value has highest weight like ½, the next closest value will have a factor of ¼, . . . etc. the farer the differential value, the lower value the weighted factors and less influence to the present pixel in predicting the M. When an abrupt change of pixel value happened, a marker, said “01010101” is inserted to break the chain of calculating differences of adjacent pixels and followed by a raw data of the next pixel as a new reference. For avoiding ambiguity, the marker bit has better to be a code that pattern never shows up in an image.

For accelerating in decoding, the M, divider is rounded to the closest value of the 2ˆˆN, said 2, 4, 8, 16, 32 . . . etc which can use the N (said 1, 2, 3, 4, 5 . . . to represent the final values 2, 4, 8, 16, 32 . . . ) of to represent it. Inserting marker bits to break the chain of differential coding and re-start a new differential helps reducing code length of the Q: Quotient, M: Divider, R: Remainder.

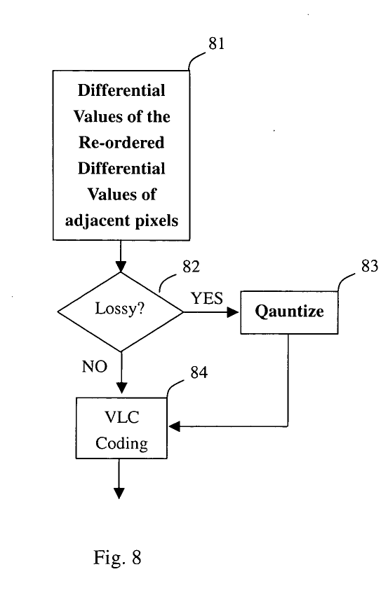

Sacrificing a little image quality will be able to further reduce the data rate of the image. FIG. 8 depicts the procedure of another alternative of this invention of image compression with lossy algorithm as an option. The Differential Values of the re-ordered differential values of adjacent pixels is put to quantization if a “Lossy” algorithm is selected, a quantization might cause data loss which can not be recovered to the original value with the benefit of shorter code to represent it. After qualtization, the final value will be coded by a VLC coding 84.

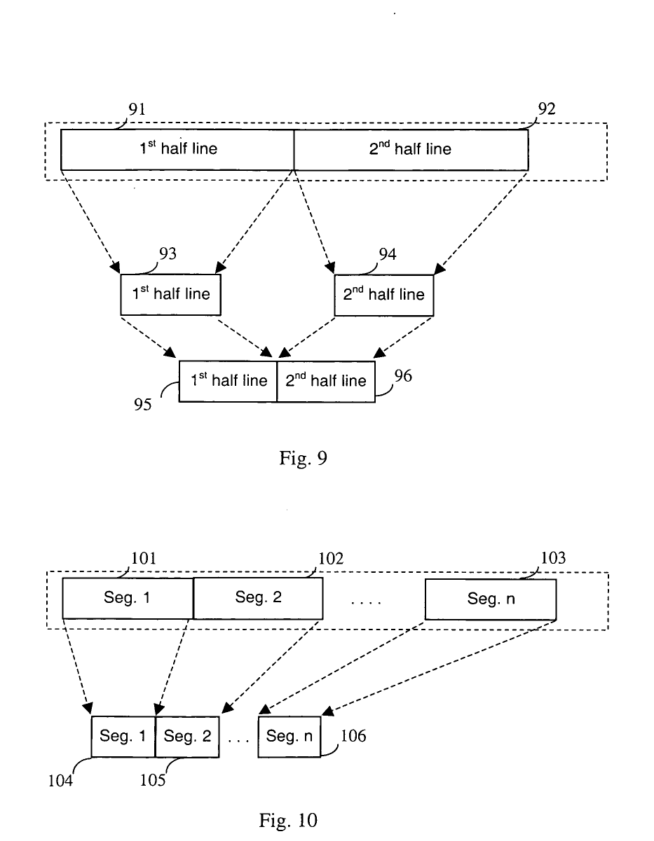

Smaller amount of pixels might be classified as a compression unit and follow all above methods and apparatus of the invention of the image compression. As shown in FIG. 9, a line of pixels are divided into two “Half Lines” 91, 92 and each of the “half line” can be compressed sequentially or in parallel into shorter codes 95, 96. Even shorter length of pixel samples can be put together to go through the similar compression procedure of this invention. The smaller length of pixels, so named “Segment” is shown in FIG. 10. As can be seen, a line of pixels is segmented into a certain amount of “segments” 101, 102, 103 and are compressed sequentially or in parallel into shorter length 104, 105, 106. In principle, the shorter the length of a segment, the faster it can be compressed at the cost of less compression rate.

The digital image mentioned in this invention of image compression includes color components of Red, Green and Blue and Y, Y, V or Y, Cb, Cr (Luma and Chroma). Which means the YIUN or Y/Cr/Cb can be compressed by the same method as describe in this invention. Another alternative can be derived from this method of this invention. Which include re-ordering the raw image data according to the magnitude of the neighboring lines and take further action of compressing the re-ordered pixels by the same procedure like described above.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of compressing digital image, comprising:
calculating the differential values of adjacent pixels within a group of pixels;
re-ordering the differential values of adjacent pixels according to the magnitude of differential pixel values of a neighboring line; and
compressing the re-ordered differential values of the adjacent pixels.

2. The method of claim 1, wherein the group of pixels is a line of pixels or a segment of pixels;

3. The method of claim 1, wherein one of a group pixels is used as the reference of the rest of the differential values of adjacent pixels;

4. The method of claim 1, wherein in re-ordering the differential values of adjacent pixels, when equal values happened, the first show up value is put in the earlier position;

5. The method of claim 1, wherein the neighboring line is an upper line;

6. The method of claim 1, wherein the neighboring line is a lower line;

7. The method of claim 1, wherein the image pixels include Red, Green, Blue or Luma and Chroma, said Y, U, V or Y, Cb and Cr.

8. The method of claim 1, wherein a certain amount of the re-ordered differences of adjacent pixels are left with no compression operation.

9. An apparatus of compressing digital image, comprising:
an calculating the differential values of adjacent pixels within a group of pixels and saving the differential values into storage devices;
a device re-ordering the differential values of adjacent pixels according to the magnitude of differential pixel values of an adjacent line by sorting the differential values saved in the storage device; and
a device compressing the re-ordered differential values of the adjacent pixels by the apparatus of
calculating the differential values of adjacent differential values within a group of pixels; and
applying a variable length coding apparatus to further compress the re-ordered differential values.

10. The apparatus of claim 9, wherein a group of pixels is a line or a segment of pixels which data is saved in a storage device.

11. The apparatus of claim 9, wherein in applying a variable length coding, a shortest code is predetermined and assigned to represent “end-of-non-zero” status.

12. The apparatus of claim 9, wherein the image component in the form of Y, U, V, or Y, Cr, and Cb follow similar compression procedure as Red, Green and Blue

13. The apparatus of claim 9, wherein during VLC coding of the re-ordered differential values, only the “Quotient” and “Remainder” are coded with the “Divider” implicitly done by prediction.

14. The apparatus of claim 9, wherein the “Divider” is calculated by taking average of adjacent weighted differential values of DCT coefficients with closer having heavier weight and farer less weight.

15. The apparatus of claim 9, wherein a certain groups of the re-ordered differential values of adjacent pixels which have higher magnitude will be coded by no further compression procedure.

16. A method of compressing digital image, comprising
detecting the complexity of a group of pixels;
if the complexity is low, then compressing the group of pixels;
if the complexity is higher than a predetermined threshold level, then compressing the group of pixels by:
inserting a marker code to break the chain of calculating the differences of adjacent pixels;
using the next raw pixel data as a new reference for calculating the differential values of adjacent pixels; and
compressing the differential values between adjacent pixels.

17. The method of claim 16, wherein a group of pixels is a segment of a line of pixels.

18. The method of claim 16, wherein a marker code is a code with a predetermined length and that pattern never shows up in an image.

19. The method of claim 16, wherein during compressing the differences of adjacent pixels, the procedure is the same to that in claim 1.
